(19) United States
(12) Patent Application Publication
(10) Pub. No.: US 2018/0250710 A1
(43) Pub. Date: Sep. 6, 2018

(54) ACOUSTIC SENSOR FOR EMITTING AND/OR RECEIVING ACOUSTIC SIGNALS

(71) Applicant: Robert Bosch GmbH, Stuttgart (DE)

(72) Inventor: Matthias Karl, Ettlingen (DE)

(21) Appl. No.: 15/754,736

(22) PCT Filed: Jun. 27, 2016
(86) PCT No.: PCT/EP2016/064836

§ 371 Date: Feb. 23, 2018

(30) Foreign Application Priority Data
Aug. 25, 2015 (DE) 102015216163.3

(51) Int. Cl. B06B 1/06; G01H 11/08; G10K 9/125; G10K 9/20

(52) U.S. Cl. CPC B06B 1/0622; G10K 9/20; G10K 9/125; G01H 11/08

(57) ABSTRACT

An acoustic sensor for emitting and/or receiving acoustic signals includes a diaphragm having a first surface and a second surface forming oppositely situated sides of the diaphragm and defining a common surface perimeter by their edge, a housing that carries the diaphragm and restricts an expansion of the surface perimeter of the diaphragm during an operation of the acoustic sensor, and a first electroacoustic transducer disposed in a first subsection of the first surface of the diaphragm, the first subsection being outside of a center of the first surface of the diaphragm.

### CROSS-REFERENCE TO RELATED APPLICATIONS

The present application is the national stage of International Pat. App. No. PCT/EP2016/064836 filed Jun. 27, 2016, and claims priority under 35 U.S.C. § 119 to DE 10 2015 216 163.3, filed in the Federal Republic of Germany on Aug. 25, 2015, the content of each of which are incorporated herein by reference in their entireties.

### FIELD OF THE INVENTION

The present invention relates to an acoustic sensor for emitting and/or receiving acoustic signals.

### BACKGROUND

A diaphragm in an acoustic sensor is typically excited with the aid of an electroacoustic transducer. This causes the diaphragm to oscillate so that the diaphragm outputs an acoustic signal. In a corresponding manner, acoustic signals can also be received via the diaphragm. The electroacoustic transducer is disposed in a center of the diaphragm in order to excite the diaphragm in a uniform manner across its entire surface.

It is also known that the diaphragm is connected to the electroacoustic transducer via a web. This amplifies a mechanical expansion of the electroacoustic transducer via a lever arm, and thereby results in a large excursion of the diaphragm, so that a more powerful acoustic signal is emitted. The document WO 2013 117 437 A1 discloses such an acoustic sensor. However, very high pointwise loading of the diaphragm is encountered in this case.

### SUMMARY

According to example embodiments of the present invention, an acoustic sensor for emitting and/or receiving acoustic signals includes a diaphragm that has a first surface and a second surface, where the first and second surfaces form opposite sides of the diaphragm and define a shared surface perimeter by their edges. The acoustic sensor also includes a housing, which carries the diaphragm and at least restricts an expansion of the surface perimeter of the diaphragm when the acoustic sensor is in operation; and a first electroacoustic transducer, which is situated in a first subsection of the first surface of the diaphragm, the first subsection being situated outside a center area of the first surface of the diaphragm.

The surface perimeter of the diaphragm is restricted in its expansion such that the surface perimeter will not vary when the diaphragm is excited by the electroacoustic transducer. The diaphragm is framed by the housing, in particular along its surface perimeter. The first electroacoustic transducer is situated on the first surface in an acentric manner, so that the first electroacoustic transducer is not situated in the center of area of the diaphragm. As a result, the first subsection lies completely outside the first center of area of the first surface of the diaphragm. The first subsection can also have a hole in which the center area of the first surface of the diaphragm lies, while the first electroacoustic transducer is disposed at a distance from this hole on the diaphragm. The center area includes a center of the diaphragm. If the diaphragm has the form of a circular disk, for example, then a center of the circle forms the center area of the diaphragm. In an example, the first and the second surfaces are essentially planar.

An advantage of an acoustic sensor according to example embodiments of the present invention is that that even a slight movement of the electroacoustic transducer can be converted into a strong movement of the diaphragm. The placement of the first electroacoustic transducer on the diaphragm according to the present invention creates especially large-area regions of the diaphragm in which no electroacoustic transducer is situated. These regions are able to oscillate at a particularly low damping resistance and are excited by the first acoustic transducer in a whip-like manner. This achieves a particularly large excursion of the diaphragm in an excitation through a small movement of the first electroacoustic transducer, thereby providing a particularly efficient acoustic sensor. Embodiments of the present invention therefore achieves a large excursion of the diaphragm on account of the lever principle.

Starting at the first subsection, a stiffness of the diaphragm preferably continually decreases in an area that abuts the first subsection. This means that the diaphragm has a higher stiffness in the region in which the first electroacoustic transducer is disposed than in the region abutting the first subsection. The stiffness of the diaphragm decreases especially because a thickness of the diaphragm decreases. More specifically, starting at the first subsection, a thickness of the diaphragm thus continually decreases in an area that abuts the first subsection. Consequently, a bending and restoring moment of the diaphragm is particularly low in the area abutting the first subsection, and the diaphragm will respond by a large excursion to a slight excitation of the abutting first subsection and therefore oscillate at a great amplitude. This results in a high emitted acoustic output and thus in high efficiency of the acoustic sensor.

It is furthermore advantageous if the acoustic sensor includes a plurality, i.e., two or more, electroacoustic transducers, each electroacoustic transducer being disposed in a respective associated subsection of the first surface of the diaphragm. The associated subsections do not overlap one another, and the associated subsections are situated outside the center area of the first surface of the diaphragm. In other words, multiple electroacoustic transducers are situated next to each other on the first surface. The first acoustic transducer is one of the electroacoustic transducers of the multitude of electroacoustic transducers. Areas that lie between the electroacoustic transducers are thus able to be excited from multiple sides in an especially efficient manner. More specifically, the electroacoustic transducers are excited by different electrical signals. This creates a sensor array with the aid of a single diaphragm.

It is also advantageous if a stiffness of the diaphragm in an area situated between the associated subsections of two electroacoustic transducers is lower than in the associated subsections of these electroacoustic transducers. The stiffness of the diaphragm is lower especially because a thickness of the diaphragm is reduced. This minimizes a bending and restoring moment of the diaphragm precisely in the region that is excited by multiple electroacoustic transducers, which in turn makes it possible to achieve a large oscillation swing of the diaphragm.

Preferably, the multitude of electroacoustic transducers is situated on a shared circuit board, and each electroacoustic transducer is fixed in position on the circuit board, so that a relative movement of the electroacoustic transducers with respect to one another is prevented. An excursion of the diaphragm in the areas between the electroacoustic transducers thus becomes greater since the diaphragm is unable to swing out in a different direction because the diaphragm is held in its initial position in the region of the electroacoustic transducers. The multitude of electroacoustic transducers is preferably mechanically connected to the diaphragm for this purpose.

It is also advantageous if the first electroacoustic transducer is an annular electroacoustic transducer and is situated on the first surface of the diaphragm by way of one of its surfaces implemented in the form of a perforated disk. The annular electroacoustic transducer especially has the form of a perforated disk, and the electroacoustic transducer is mechanically connected to the diaphragm, in particular. This allows for an especially pronounced oscillation of the diaphragm in the interior of the annular electroacoustic transducer inasmuch as the diaphragm is excited from all sides in the interior of the ring by the electroacoustic transducer, and the diaphragm is unable to swing out toward the side, in particular. This creates an especially efficient acoustic sensor.

It is furthermore preferred that a stiffness of the diaphragm in the first subsection, in which the annular electroacoustic transducer is situated, is greater than in a subsection that is framed by the annular electroacoustic transducer. The stiffness of the diaphragm is lower especially because a thickness of the diaphragm is lower. A bending moment of the diaphragm in this framed subsection is therefore reduced, and this framed subsection is excited to a particularly strong oscillation. A particularly strong oscillation is characterized by a particularly large amplitude of the radiated sound pressure.

It is also advantageous if the diaphragm includes a depression, which extends along the edge of the diaphragm and encircles all electroacoustic transducers disposed on the diaphragm. A depression is a thinned area of the diaphragm. By proper dimensioning of such a thinned area, a maximum excursion of the diaphragm and its resonant frequency are able to be adjusted.

It is also advantageous if the acoustic sensor additionally includes a support element, which is situated on the side of the first surface of the diaphragm and forms a stop that restricts a maximum amplitude of the diaphragm. In particular, the support element has a surface structure whose extension corresponds to a surface contour of the first surface of the diaphragm. Moreover, it is advantageous if the support element is a circuit board, which then makes it possible to protect the diaphragm from excessive bending such as by a blunt impact. The maximum amplitude of the diaphragm is a maximum excursion of the diaphragm.

It is furthermore advantageous that the electroacoustic transducer is a piezo element or a bimetal. A piezo element and a bimetal are both able to execute a small movement rapidly and with great force. This makes it possible to produce an acoustic sensor that has a particularly great lever arm, and the electroacoustic transducer generates sufficient force to excite the diaphragm via this lever.

In the following text, exemplary embodiments of the present invention are described in detail with reference to the appended drawings.

### BRIEF DESCRIPTION OF THE DRAWINGS

FIG. 1 illustrates an acoustic sensor according to a first example embodiment of the present invention.

FIG. 2 illustrates a diaphragm of an acoustic sensor according to a second example embodiment of the present invention.

FIG. 3 illustrates an acoustic sensor according to a third example embodiment of the present invention.

FIG. 4 illustrates an acoustic sensor according to a fourth example embodiment of the present invention.

FIG. 5 illustrates an acoustic sensor according to a fifth example embodiment of the present invention.

FIG. 6 illustrates an acoustic sensor according to a sixth example embodiment of the present invention.

### DETAILED DESCRIPTION

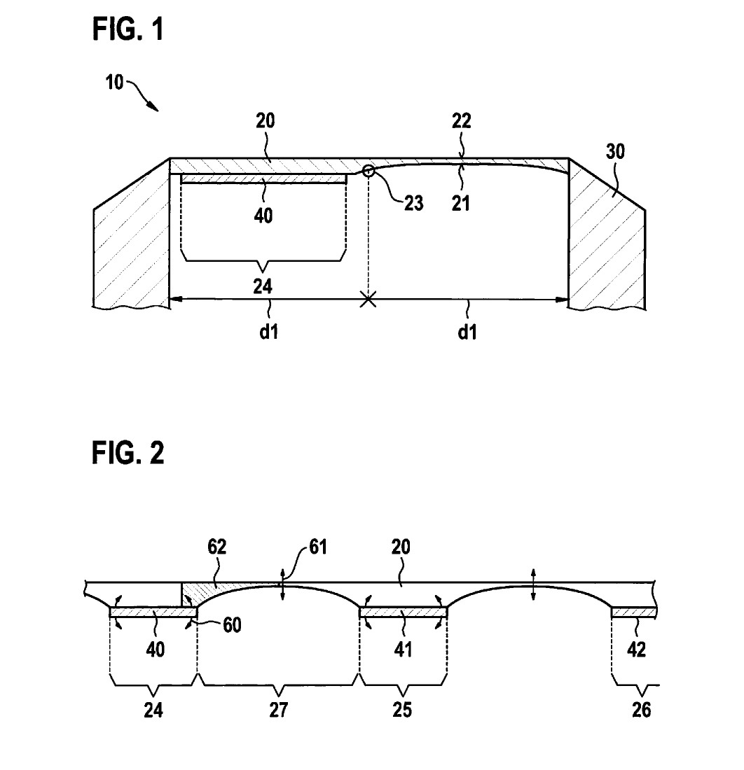

FIG. 1 shows an acoustic sensor 10 according to a first example embodiment of the present invention. Acoustic sensor 10 includes a diaphragm 20, a housing 30, and a first electroacoustic transducer 40.

In this first example embodiment, diaphragm 20 has the form of a circular disk, which has a variable thickness. The two oppositely located surfaces 21, 22 of diaphragm 20 are a first surface 21 and a second surface 22. First surface 21 and second surface 22 thus form oppositely disposed sides of the diaphragm. Second surface 22 lies on a side of diaphragm 20 on which acoustic sensor 10 emits an acoustic signal to its environment in order to sense an environment of acoustic sensor 10. The edge of first surface 21 and the edge of second surface 22 define a common surface perimeter of diaphragm 20. In this first example embodiment, the surface perimeter of the diaphragm is the circular outer perimeter of diaphragm 20 in the shape of a circular disk. A thickness of diaphragm 20 is a distance between first surface 21 and second surface 22. Diaphragm 20 is made from a flexible material.

Diaphragm 20 can be produced from all kinds of materials such as aluminum, fiber-reinforced composites, rubber, plastics and similar materials and is able to be produced according to specifications by casting, extruding, and/or by post-processing such as grinding, drilling and laser treatments.

In this first example embodiment, housing 30 has the form of a pot. Diaphragm 20 spans an opening of this pot and thus an opening of housing 30. The edge of diaphragm 20 is welded to housing 30. Housing 30 is produced from a material that has a lower elasticity than diaphragm 20. An expansion of the surface perimeter of diaphragm 20 is therefore restricted to the expansion of the opening of housing 30. Regardless of the manner in which diaphragm 20 is excited when acoustic sensor 10 is in operation, its surface perimeter is unable to further expand because it is restricted by housing 30. An expansion of the surface perimeter of diaphragm 20 during an operation of acoustic sensor 10 is therefore at least restricted. The edge of the diaphragm is held in a base plane of diaphragm 20, which in this first example embodiment is a plane in which diaphragm 20 in the form of a circular disk is situated.

As a result, diaphragm 20 is laterally clamped in housing 30. A change in length of first electroacoustic transducer 40 induced by applying an electric voltage to first electroacoustic transducer 40 forces diaphragm 20 to bend, and thus forces it to execute an evasive movement out of the housing. Because diaphragm 20 is excited outside of center of area 23, a lever, via which an excursion of diaphragm 20 is generated, is maximized.

In this first example embodiment, electroacoustic transducer 40 is a piezo element or a bimetal. First electroacoustic transducer 40 is situated in a first subsection 24 of first surface 21 of the diaphragm. Therefore, first subsection 24 of first surface 21 is an area on first surface 21 of diaphragm 20 that is covered by first electroacoustic transducer 40. First subsection 24 is situated completely outside a center of area 23 of first surface 21 of diaphragm 20. First surface 21 is a round surface in this first example embodiment. As a result, center of area 23 is a center point of the first surface, and a constant distance d1 exists between center of area 23 and the edge of diaphragm 20. Distance d1 is a radius of circular diaphragm 20, and thus of first surface 21. First electroacoustic transducer 40 is disposed between the edge of diaphragm 20 and center of area 23 of first surface 21. In this first example embodiment, first electroacoustic transducer 40 is a component that has the shape of a circular disk and a diameter that is smaller than distance d1.

Starting at first subsection 24, a stiffness of diaphragm 20 continually decreases in a region that abuts first subsection 24. In the first example embodiment, this is achieved in that a thickness of diaphragm 20 is greater in first subsection 24 than in the other regions of diaphragm 20, a continuous transition being provided between first subsection 24 and the other regions of diaphragm 20. Diaphragm 20 therefore has a constant first thickness in the first subsection 24. Outside of first subsection 24, the thickness of diaphragm 20 continually decreases until it is reduced to a second thickness that is less than the first thickness. First subsection 24 having the first thickness is shown on the left in FIG. 1, and a region having the second thickness is shown on the right in FIG. 1. Situated between these regions of different thicknesses is the region that abuts first subsection 24, in which the thickness of diaphragm 20 continually decreases.

FIG. 2 shows a diaphragm 20 of an acoustic sensor 10 according to a second example embodiment of the present invention. The second example embodiment in principle corresponds to the first example embodiment but a multitude of electroacoustic transducers 40, 41, 42 is situated on diaphragm 20 in this second example embodiment. Each electroacoustic transducer 40, 41, 42 is situated in a respective associated subsection 24, 25, 26 of first surface 21 of diaphragm 20. Accordingly, first electroacoustic transducer 40 is disposed in first subsection 24, a second electroacoustic transducer 41 is situated in a second subsection 25, and a third electroacoustic transducer 42 is situated in a third subsection 26. Associated subsections 24, 25, 26 do not overlap one another.

In this second example embodiment, a region 27 lies between first electroacoustic transducer 40 and second electroacoustic transducer 41, and thus between first subsection 24 and second subsection 25. In this region 27, which is situated between associated subsections 24, 25, a stiffness of diaphragm 20 is less than in first subsection 24 and in second subsection 25. This is accomplished in that the thickness of the diaphragm continually decreases starting from the first subsection and then increases again only halfway between the first subsection and the second subsection. Through its cross-section, diaphragm 20 thus forms an arc between first electroacoustic transducer 40 and second electroacoustic transducer 41. In a corresponding manner, diaphragm 20 forms an arc between second electroacoustic transducer 41 and third electroacoustic transducer 42. Any number of electroacoustic transducers 40, 41, 42 can be placed on the diaphragm in this way, and a sensor array is able to be produced thereby.

A mode of action that applies to each of the described example embodiments will be described in connection with FIG. 2. With the aid of a first arrow 60, which is shown at the edge of the first electroacoustic transducer, a movement of first electroacoustic transducer 40 when it is excited by an electrical signal is sketched. Depending on the choice of first electroacoustic transducer 40, first electroacoustic transducer 40 will bend, expand, or bend and expand in response to an excitation. It should be assumed that first electroacoustic transducer 40 bends during an excitation. This subjects a section 62 of the diaphragm disposed at the outer edge of first electroacoustic transducer 40 to a torque, which is indicated by first arrow 60. Section 62 of the diaphragm is a region of the diaphragm that extends away from first electroacoustic transducer 40 starting at first electroacoustic transducer 40. It is clear that even a slight movement of first electroacoustic transducer 40 leads to a considerably greater movement of diaphragm 20 when an end of section 62 that is disposed at a distance from first electroacoustic transducer 40 is examined. This is sketched by a second arrow 61 in FIG. 2. This section 62 of diaphragm 20 thus creates a lever arm that converts a slight mechanical movement of electroacoustic transducer 40 into a large excursion of diaphragm 20, with the result that when the diaphragm is made to oscillate by electroacoustic transducer 40, an amplitude or an excursion of diaphragm 20 is considerably greater in the regions that are located at a distance from electroacoustic transducers 40, 41, 42 than in associated subsections 24, 25, 26 in which electroacoustic transducers 40, 41, 42 are disposed.

This mode of action also applies when first electroacoustic transducer 40 is selected in such a way that it expands along first surface 21. Since housing 30 restricts the expansion of the surface perimeter of diaphragm 20, diaphragm 20 will execute an evasive movement out of the base plane of diaphragm 20 via an excursion that corresponds to second arrow 61. Even a slight mechanical movement of first electroacoustic transducer 40 thereby produces a large excursion of diaphragm 40.

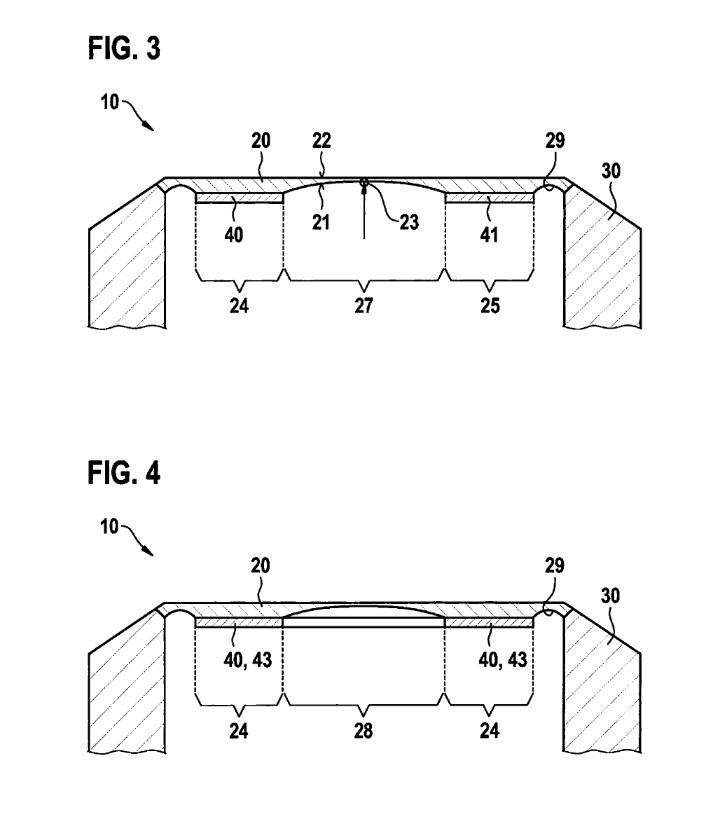

FIG. 3 shows an acoustic sensor 10 according to a third example embodiment of the present invention. The third example embodiment of the present invention corresponds to the previously described example embodiments of the invention. Acoustic sensor 10 includes first electroacoustic transducer 40 and second electroacoustic transducer 41, and thus a plurality of electroacoustic transducers. First electroacoustic transducer 40 is situated in first subsection 24, and second electroacoustic transducer 41 is situated in second subsection 25. Region 27, which lies between associated subsections 24, 25, i.e., first subsection 24 and second subsection 25, has a lower stiffness than first subsection 24 and second subsection 25, similar to the second example embodiment. Both first subsection 24 and second subsection 25 lie between center of area 23 of diaphragm 20 and the edge of diaphragm 20. As a result, the subsections associated with the first and second electroacoustic transducers 40, 41 lie completely outside center of area 25 of first surface 21 of diaphragm 20. First subsection 24 and second subsection 25 do not overlap each other.

In this third example embodiment, diaphragm 20 has a depression 29, which extends along the edge of diaphragm 20 and encircles all electroacoustic transducers 40, 41 situated on diaphragm 20. Depression 29 is a tapering of the thickness of diaphragm 20. A trench, which has a circular characteristic along the edge of diaphragm 20, therefore extends on first surface 21 of diaphragm 20 on account of depression 29. Electroacoustic transducers 40, 41 are disposed within this annular extension of depression 29.

Because of the shape of diaphragm 20, the directional characteristic, and the maximum excursion, the resonant frequency and other parameters of acoustic sensor 10 are able to be adjusted without any change in electroacoustic transducers 40, 41, 42. This is also accomplished with the aid of depression 29. For example, depression 29 centers a movement of diaphragm 20, which induces a larger opening angle at a greater acoustic oscillation swing. If depression 29 is omitted and the electroacoustic transducer is positioned farther outside on diaphragm 20, then a greater sound-radiating area of diaphragm 20 is obtained and thus a narrower directional characteristic at a lower acoustic swing.

The region between electroacoustic transducers 40, 41 can furthermore include additional depressions, which are not depicted in FIG. 3.

FIG. 4 shows an acoustic sensor 10 according to a fourth example embodiment of the present invention. The fourth example embodiment of the present invention corresponds to the first through the third example embodiments of the present invention. However, instead of a plurality of electroacoustic transducers, the acoustic sensor includes only first electroacoustic transducer 40, which, in this example embodiment, is embodied as an annular electroacoustic transducer 43, which essentially has the form of a perforated disk. Via one of its perforated-disk surfaces, annular electroacoustic transducer 43 is situated on first surface 21 of diaphragm 20. Annular electroacoustic transducer 43, and thus first subsection 24, encircles center of area 23 of first surface 21 of diaphragm 20.

The stiffness of diaphragm 20 in first subsection 24 in which annular electroacoustic transducer 43 is situated is greater than in a subsection 28 that is framed by annular electroacoustic transducer 43. This subsection 28 is therefore the area of diaphragm 20 that lies within the inner annular perimeter of electroacoustic transducer 43. The thickness of diaphragm 20 in this subsection 28 is less than in first subsection 24.

The area inside annular electroacoustic transducer 43 can furthermore include additional depressions not shown in FIG. 4.

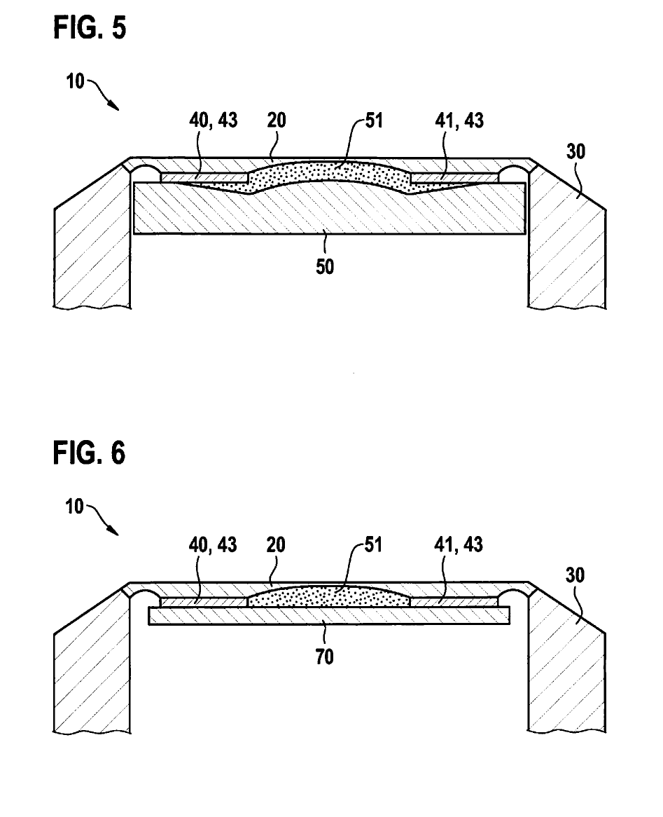

FIG. 5 shows an acoustic sensor 10 according to a fifth example embodiment of the present invention. The fifth example embodiment corresponds to the first through the fourth example embodiments of the present invention. Acoustic sensor 10 additionally includes a support element 50, which is situated on the side of first surface 21 of diaphragm 20 and forms a stop that restricts a maximum amplitude, and thus a maximum excursion, of diaphragm 20. Support element 50 is placed in an interior of acoustic sensor 10. A surface of support element 50 situated on the side of diaphragm 20 is shaped in such a way that when support element 50 is disposed in acoustic sensor 10, a gap is created between support element 50 and diaphragm 20 having electroacoustic transducers 40, 41, which gap has an essentially constant gap thickness. In an example, the extension of this gap is minimized only in the region of electroacoustic transducers 40, 41 in order to allow for contacting of electroacoustic transducers 40, 41. It is advantageous in this context for support element 50 to also be a circuit board. Contacting is then able to take place via circuit traces that are situated on support element 50. An elastic adsorption material 51 is disposed in the gap, in particular. Support element 50 is fixed in position in relation to housing 30. If a blunt impact occurs on second surface 22 of diaphragm 20, then diaphragm 20 is pushed in the direction of support element 50 and sets down thereon. Diaphragm 20 is therefore unable to be overstretched and tear.

FIG. 6 shows an acoustic sensor 10 according to a sixth example embodiment of the present invention. In this sixth example embodiment, which essentially corresponds to the second, third and fifth example embodiments, the plurality of electroacoustic transducers 40, 41 is disposed on a shared circuit board 70. This fixates a position of electroacoustic transducers 40, 41 relative to one another. First electroacoustic transducer 40 and second electroacoustic transducer 41 are therefore unable to be pushed apart in an excitation of diaphragm 20. As a result, diaphragm 20 in the region between first electroacoustic transducer 40 and second electroacoustic transducer 41 is forced to oscillate at a greater amplitude when excited by the first and second electroacoustic transducer 40, 41.

With respect to all of the described example embodiments, it is advantageous if the stiffness of diaphragm 20 is adapted via a thickness of diaphragm 20. Sensitive regions of acoustic sensor 10, in which electroacoustic transducers 40, 41, 42 are situated, are then protected by a thicker and thus more robust diaphragm than the other regions of acoustic sensor 10. At the same time, the regions of diaphragm 20 in which no electroacoustic transducer 40, 41, 42 is situated, are low in mass and therefore are able to generate a narrow directional characteristic across a large area.

In all of the described example embodiments of the present invention, a stiffness of diaphragm 20 is also adaptable by producing diaphragm 20 from different materials. This makes it possible to provide a sensor according to the present invention that has a diaphragm 20 of a constant thickness.

In further preferred example embodiments, diaphragm 20 is composed of different layers. Here, the electroacoustic transducer can be situated between two layers of diaphragm 20.

In addition to the above disclosure, explicit reference is also made to the disclosure of FIGS. 1-6.

1-10. (canceled)

11. An acoustic sensor for at least one of emitting and receiving acoustic signals, the sensor comprising:
a diaphragm including a first surface and a second surface forming opposite sides of the diaphragm and defining, by their edges, a shared surface perimeter;
a housing that carries the diaphragm and restricts an expansion of the surface perimeter of the diaphragm during an operation of the acoustic sensor; and
a first electroacoustic transducer arranged on a first subsection of the first surface of the diaphragm, the first subsection being located outside a center of the first surface of the diaphragm.

12. The acoustic sensor of claim 11, wherein a stiffness of the diaphragm in an area abutting the first subsection continuously decreases in a direction extending away from the first subsection.

13. The acoustic sensor of claim 11, wherein:
the acoustic sensor includes a plurality of electroacoustic transducers, including the first electroacoustic transducer;
each of the plurality of electroacoustic transducers is arranged on a respective one of a plurality of non-overlapping subsections of the first surface of the diaphragm, including the first subsection; and
all of the plurality of subsections on which respective ones of the plurality of electroacoustic transducers are arranged are located outside the center of the first surface of the diaphragm.

14. The acoustic sensor of claim 13, wherein a stiffness of the diaphragm in a region that lies between two of the plurality of subsections on which two adjacent ones of the plurality of electroacoustic transducers are arranged is lower than in the two of the plurality of subsections.

15. The acoustic sensor of claim 13, wherein the plurality of electroacoustic transducers are arranged on a shared circuit board.

16. The acoustic sensor of claim 13, wherein the diaphragm includes a depression that extends along a edge of the diaphragm and encircles all of the electroacoustic transducers arranged on the diaphragm.

17. The acoustic sensor of claim 11, wherein the first electroacoustic transducer is an annular, perforated electroacoustic transducer, with one of its surfaces being arranged on the first surface of the diaphragm.

18. The acoustic sensor of claim 17, wherein a stiffness of the diaphragm in the first subsection, in which the annular electroacoustic transducer is situated, is greater than in a subsection of the first surface of the diaphragm that is framed by the annular electroacoustic transducer.

19. The acoustic sensor of claim 11, further comprising a support element that is arranged at the side of the diaphragm formed by the first surface and that forms a stop that restricts a maximum amplitude of the diaphragm.

20. The acoustic sensor of claim 11, wherein the first electroacoustic transducer is a piezo element or a bimetal.
